(19) United States
(12) Patent Application Publication
(10) Pub. No.: US 2021/0136886 A1
(43) Pub. Date: May 6, 2021

(54) LIGHT HAVING SELECTIVELY ADJUTABLE SETS OF SOLID STATE LIGHT SOURCES, CIRCUIT AND METHOD OF OPERATION THEREOF, TO PROVIDE VARIABLE OUTPUT CHARACTERISTICS

(71) Applicant: Express Imaging Systems, LLC, Renton, WA (US)

(72) Inventor: William G. Reed, Seattle, WA (US)

(21) Appl. No.: 17/088,395

(22) Filed: Nov. 3, 2020

Related U.S. Application Data
(60) Provisional application No. 62/930,283, filed on Nov. 4, 2019.

(51) Int. Cl. H05B 45/10; H05B 45/345; H05B 45/48; H05B 45/20; F21S 8/08; F21V 29/503; F21V 29/70

(52) U.S. Cl. CPC H05B 45/10; H05B 45/345; H05B 45/48; F21W 2131/103; F21S 8/088; F21V 29/503; F21V 29/70; H05B 45/20

(57) ABSTRACT

A light having a first set of electrically coupled solid state light sources having a first forward voltage drop and a second set of electrically coupled solid state light sources having a second forward voltage at least approximately matching the first forward voltage drop. The first set and second sets of solid state light sources are electrically coupled in parallel to a constant current source. A resistor is electrically coupled to at least one of the first and second sets of solid state light sources. Control circuitry is operably coupled to control a resistance electrically coupled in series with said at least one of the first set and the second set of solid state light sources to adjust a respective current therethrough and thereby dim said at least one of the first set and the second set of solid state light sources while maintaining the respective forward voltage drops.

### BACKGROUND

### Technical Field

The present application is directed to a light, circuitry and method in which sets of solid state light sources are selectively adjustable to provide variable output characteristics, such as light distribution patterns and color temperatures.

### Description of the Related Art

Lighting applications generally require lights with specific characteristics, such as specific illumination patterns, color temperatures, etc. Some lighting applications, such as roadway lighting, may require lights, e.g., luminaires, having characteristics which depend on the specifications of a particular installation. In such cases, it may be necessary to produce, install, and maintain a variety of different types of lights, each designed for a specific type of installation. Lights, e.g., luminaires, vehicle headlamps, including sets of solid state light sources may have characteristics which can be changed during use. For example, the brightness of a luminaire can be changed by dimming the solid state light sources contained therein. In conventional approaches, dimming of the solid state light sources may be performed using resistive elements, such as load resistors and potentiometers. In such cases, significant amounts of energy may be wasted due to power dissipation in the resistive elements.

### BRIEF SUMMARY

A light may be summarized as including: a first set of one or more electrically coupled solid state light sources having a first forward voltage drop across the first set of solid state light sources; a second set of one or more electrically coupled solid state light sources having a second forward voltage drop across the second set of solid state light sources, the second forward voltage drop at least approximately matching the first forward voltage drop; a constant current source to which the first set of solid state light sources and at least the second set of solid state light sources are electrically coupled in parallel; at least one resistor electrically coupled to at least one of the first set and the second set of solid state light sources; and a set of control circuitry that is operably coupled to control a resistance electrically coupled in series with said at least one of the first set and the second set of solid state light sources, the resistance being provided by said at least one resistor, to adjust a respective current through said at least one of the first set and the second set of solid state light sources and thereby dim said at least one of the first set and the second set of solid state light sources while maintaining the respective forward voltage drop across the first set and the second set of solid state light sources substantially constant.

The set of control circuitry may be operably coupled to control the resistance electrically coupled in series with said at least one of the first set and the second set of solid state light sources, the resistance being provided by said at least one resistor, to adjust the respective current through said at least one of the first set and the second set of solid state light sources and thereby dim said at least one of the first set and the second set of solid state light sources and to brighten correspondingly another one of the first set and the second set of solid state light sources. The set of control circuitry may include: a shunt path bypassing said at least one resistor; and at least one switch operable in a first state to cause current to pass through said at least one resistor and operable in a second state to cause current to pass through the shunt path. The at least one switch may include a solid state switch. The at least one switch may include a mechanical or electromechanical switch. The at least one resistor may be a variable resistor and the set of control circuitry may be operable to adjust a resistance of the variable resistor. The first set and the second set of solid state light sources each may include a chip-on-board light emitting diode circuit. The first set and the second set of solid state light sources are communicatively coupled to a common isothermal structure comprising a heatsink. The first set and the second set of solid state light sources may have a negative thermal coefficient of less than about 3 millivolts per degree Celsius.

The first set of one or more solid state light sources may have a first correlated color temperature and the second set of one or more solid state light sources may have a second correlated color temperature, the first correlated color temperature being different from the second correlated color temperature, and the set of control circuitry may be operably coupled to control the resistance electrically coupled in series with said at least one of the first set and the second set of solid state light sources, the resistance being provided by said at least one resistor, to adjust the respective current through said at least one of the first set and the second set of solid state light sources and thereby dim said at least one of the first set and the second set of solid state light sources to output light having a combined correlated color temperature in a range between the first correlated color temperature and the second correlated color temperature. The second set of one or more solid state light sources may be arranged to extend along a first axis and at least the first set of one or more solid state light sources may be arranged to extend along a second axis, the second axis being non-parallel to the first axis. The second axis may be perpendicular to the first axis and the light may further include a mount positioned and oriented to allow installation of the light so that the first axis is aligned with an elongate area to provide maximum illumination to the elongate area and the second axis is aligned perpendicularly to the elongate area.

At least the first set of one or more solid state light sources may be selectively dimmable to form: a first illumination pattern; and a second illumination pattern, the second illumination pattern different than the first illumination pattern. The first illumination pattern may provide maximum illumination to an elongate area with a light distribution having a lateral width of between about 20 degrees and about 30 degrees, the second illumination pattern may provide maximum illumination to an elongate area with a light distribution having a lateral width of between about 30 degrees and about 50 degrees, and at least the first set of one or more solid state light sources may be selectively dimmable to further form a third illumination pattern which may provide maximum illumination to a circular area. The first, second, and third illumination patterns may correspond to IESNA Types II, III, and V light distribution patterns, respectively.

The light may further include: a third set of one or more electrically coupled solid state light sources having a third forward voltage drop across the third set of solid state light sources, the third forward voltage drop at least approximately matching the first forward voltage drop, wherein the first set, the second set, and the third set of solid state light sources are electrically coupled to the constant current source in parallel, said at least one resistor is electrically coupled to at least one of the first set, the second set, and the third set of solid state light sources, and the set of control circuitry is operably coupled to control a resistance electrically coupled in series with said at least one of the first set, the second set, and the third set of solid state light sources, the resistance being provided by said at least one resistor, to adjust a respective current through said at least one of the first set, the second set, and the third set of solid state light sources and thereby dim said at least one of the first set, the second set, and the third set of solid state light sources, wherein the control circuitry is operable to selectively dim one or more of the first, the second and the third sets of one or more solid state light sources to at least one of adjust a combined color temperature output by the light or to adjust a combined illumination pattern produced by the light.

A method to control a light may be provided, the light having a first set of one or more electrically coupled solid state light sources having a first forward voltage drop across the first set of solid state light sources, and a second set of one or more electrically coupled solid state light sources having a second forward voltage drop across the second set of solid state light sources, the second forward voltage drop at least approximately matching the first forward voltage drop. The method may be summarized as including: receiving current from a constant current source to which the first set of solid state light sources and at least the second set of solid state light sources are electrically coupled in parallel; and controlling, using an operably coupled set of control circuitry, a resistance electrically coupled in series with said at least one of the first set and the second set of solid state light sources, the resistance provided by at least one resistor electrically coupled to at least one of the first set and the second set of solid state light sources, to adjust a respective current through said at least one of the first set and the second set of solid state light sources and thereby dim said at least one of the first set and the second set of solid state light sources.

In said controlling the resistance electrically coupled in series with said at least one of the first set and the second set of solid state light sources to adjust the respective current through said at least one of the first set and the second set of solid state light sources and thereby dim said at least one of the first set and the second set of solid state light sources, the respective forward voltage drop across the first set and the second set of solid state light sources may remain substantially constant. The first set of one or more solid state light sources may have a first correlated color temperature and the second set of one or more solid state light sources may have a second correlated color temperature, the first correlated color temperature being different from the second correlated color temperature; and controlling the resistance electrically coupled in series with said at least one of the first set and the second set of solid state light sources to adjust the respective current through said at least one of the first set and the second set of solid state light sources may include controlling the resistance to output light having a combined correlated color temperature in a range between the first correlated color temperature and the second correlated color temperature.

The light may further include a third set of one or more electrically coupled solid state light sources having a third forward voltage drop across the third set of solid state light sources, and at least a fourth set of one or more electrically coupled solid state light sources having a fourth forward voltage drop across the fourth set of solid state light sources, the third and the fourth forward voltage drops at least approximately matching the first forward voltage drop, and at least one of the third or the fourth sets of one or more electrically coupled solid state light sources extending in a direction that is non-parallel a direction in which at least one of the first or the second sets of one or more electrically coupled solid state light sources extend, wherein controlling the resistance electrically coupled in series with said at least one of the first set and the second set of solid state light sources to adjust the respective current through said at least one of the first set and the second set of solid state light sources may include controlling a resistance electrically coupled in series with said first, second, third and fourth sets of one or more electrically coupled solid state light sources to select a throw pattern cast by the light.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn, are not necessarily intended to convey any information regarding the actual shape of the particular elements, and have been solely selected for ease of recognition in the drawings.

FIG. 1 is an isometric view of a light, in the form of a luminaire, positioned with respect to a elongate area, for example a roadway, the light having a plurality of sets of light sources arranged along two axes, the axes perpendicular to one another, and operable to produce two or more light distribution patterns to, for example, illuminate the elongate area, according to at least one illustrated implementation.

FIG. 2 is an isometric view of a light, in the form of a luminaire, having a plurality of sets of solid state light sources, the sets arranged along two axes, the axes perpendicular to one another, according to at least one illustrated implementation.

FIGS. 3A-3E are schematic diagrams showing Illumination Engineering Society light distribution patterns identified as Type I through Type V, respectively.

FIG. 4A is a circuit schematic diagram that shows a circuit comprising four sets of solid state light sources (e.g., LEDs) electrically coupled in parallel with one another to a constant current source, a respective resistor electrically coupled in series with each set of solid state light sources, and a respective shunt path provided via a solid state switch for each set, according to at least one illustrated implementation.

FIG. 4B is a plan view of a set of LEDs in a chip-on-board configuration mounted on a metal heatsink.

FIG. 5 is a plot of current versus voltage for a number of interconnected solid-state light sources of a light source circuit, according to at least one illustrated implementation.

FIG. 6 is a circuit schematic diagram that shows a circuit comprising four sets of solid state light sources (e.g., LEDs) electrically coupled in parallel with one another to a constant current source, a respective resistor, and respective shunt path with a switch, the resistors having a same value of resistance as one another, the switches illustrated in an open state and thus not providing any shunt around the corresponding resistors, according to at least one illustrated implementation.

FIG. 7 is a circuit schematic diagram that shows a circuit comprising four sets of solid state light sources (e.g., LEDs) electrically coupled in parallel with one another to a constant current source, a respective resistor, and respective shunt path with a switch for each set, the resistors having a same value of resistance as one another, two of the switches illustrated as in an open state, thus not providing a shunt around the corresponding resistors, and two of the switches illustrated as in a closed state to provide shunts around the corresponding resistors, according to at least one illustrated implementation.

FIG. 8 is a circuit schematic diagram that shows a circuit comprising four sets of solid state light sources (e.g., LEDs) electrically coupled in with one another parallel to a constant current source, a respective resistor, and a shunt path with a switch for each set, the resistors associated with two of the sets a higher value of resistance than the resistors associated with the other two sets, two of the switches that optionally provide shunt paths around the resistors having the relatively higher resistance illustrated in an open state, and two of the switches that optionally provide shunt paths around the resistors having relatively lower resistance illustrated in a closed state, according to at least one illustrated implementation.

FIG. 9 is a circuit schematic diagram that shows a circuit comprising four sets of solid state light sources (e.g., LEDs) electrically coupled in parallel with one another to a constant current source, a respective resistor, and a shunt path with a switch for each set, the resistors of two of the sets having a higher resistance than the resistors of the other two sets, the switch that optionally provides one of the shunt paths around one of the resistors having the relatively lower resistance being illustrated in an open state, and the switches that optionally provide the other shunt paths illustrated in a closed state, according to at least one illustrated implementation.

FIG. 10 is a circuit schematic diagram that shows a circuit comprising four sets of solid state light sources (e.g., LEDs) electrically coupled in parallel to a constant current source, a resistor and a first switch electrically coupled in series with one of the sets of solid state light sources along with a switch that provides a shunt path to bypass the resistor, another switch electrically coupled to another one of the sets of solid state light sources without a respective resistor or shunt path, according to at least one illustrated implementation.

FIG. 11 is a circuit schematic diagram that shows two sets of solid state light sources (e.g., LEDs) electrically coupled in with one another parallel with one another to a constant current source, a respective resistor, and respective shunt path with a switch for each set, the solid state light sources of at least one of the sets having a higher color temperature than a respective color temperature of the solid state light sources of at least one of the other sets of solid state light sources, according to at least one illustrated implementation.

### DETAILED DESCRIPTION

Various implementations may employ two or more sets of solid state light sources, the sets forward voltage matched, and control circuitry that selectively dims some sets of light sources while maintaining the respective forward voltage drop across the sets of solid state light sources substantially constant by selectively providing respective shunt paths around resistances for the respective sets of solid state light sources. Such may advantageously be employed control an amount of illumination, a combined color temperature, and/or a throw pattern using a simple and reliable circuit.

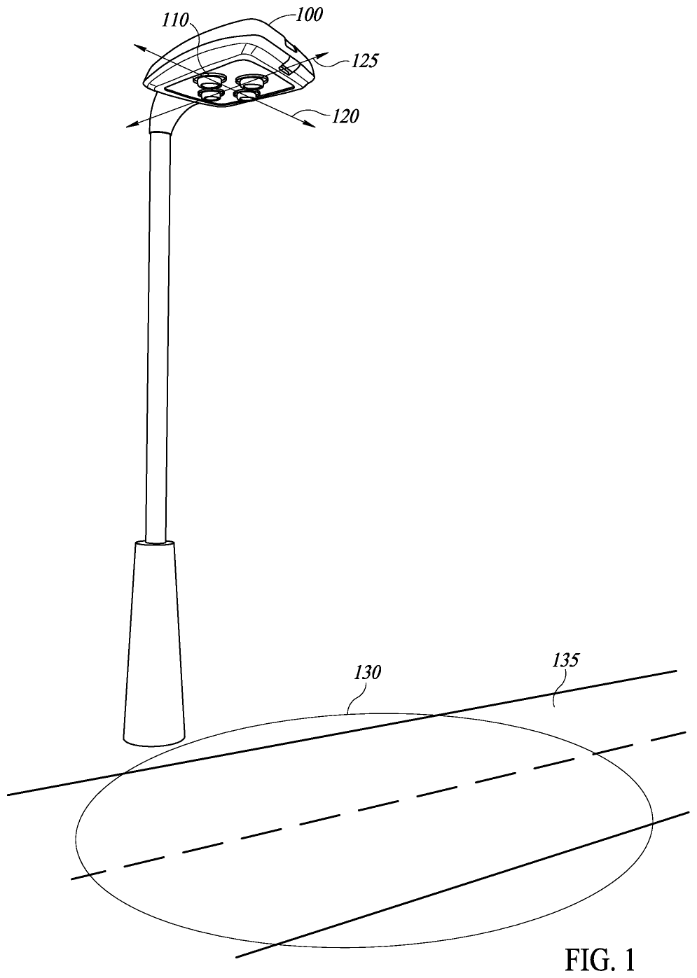

FIG. 1 shows a light, in the form of a luminaire 100, having two or more sets of light sources 110, e.g., solid state light sources, such as light emitting diodes (LED). In the example depicted, there is a first set of two light sources 110 (along a first axis 120) and a second set of two light sources 110 (along a second axis 125). As discussed in further detail below, a set of control circuitry may be provided in the luminaire 100 to adjust a respective current through the sets of light sources, thereby selectively dimming the sets of light sources 110.

The sets of light sources 110 may be arranged in sets of light sources, the light sources in each set electrically coupled in series with one another and operable together with one another. The light sources of each set of light sources may be aligned along a respective axis of the set, or may be distributed in some other pattern, for example aligned along a curve or along an arc, or positioned in a two-dimensional array. The sets of light sources may be arranged spatially and angularly offset from one another. For example, when arrayed along respective axes 120, 125, those axes 120, 125 may be non-parallel to one another, or even perpendicular to one another. This may allow the luminaire 100 to produce one or more light distribution patterns to illuminate an elongate area 130 of a surface, e.g., a roadway 135, according to at least one illustrated implementation.

The light sources 110 may be selectively dimmed to provide a different illumination pattern along each of the axes (120 and 125). In the example depicted, a first axis 120 of the two perpendicular axes is aligned with an elongate area 130 to be illuminated, e.g., a roadway 135 or pathway, ground or other area to be illuminated. A second axis 125 of the two perpendicular axes is non-parallel, e.g., perpendicular, with respect to the first axis 120, so as to be in a direction of roadside or path-side objects such as residences and buildings. In implementations, the light sources 110 of the luminaire 100 may include, e.g., two solid state light sources 110, e.g., light emitting diode (LED) light sources, arranged along the first axis 120 (one on each side of a center point where the axes intersect) and, e.g., two solid-state light sources 110 arranged along the second axis 125 (one on each side of the center point). Each of the solid-state light sources 110 may be constituted by a single or multiple individual solid-state elements, e.g., LEDs. In other implementations, there may be at least a first set (e.g., string) of LED light sources arranged along the first axis 120 (or, for example, two separate strings arranged on either side of the center point where the axes intersect) and at least a second string of LED light sources arranged along the second axis 125 (or, for example, two separate strings arranged on either side of the center point). The first and second sets of LED light sources may have the same or a different number of light sources. For example, in implementations, there may be more LED light sources in the set(s) of LED sources aligned with the first axis 120 than in the set(s) of LED light sources aligned with the second axis 125.

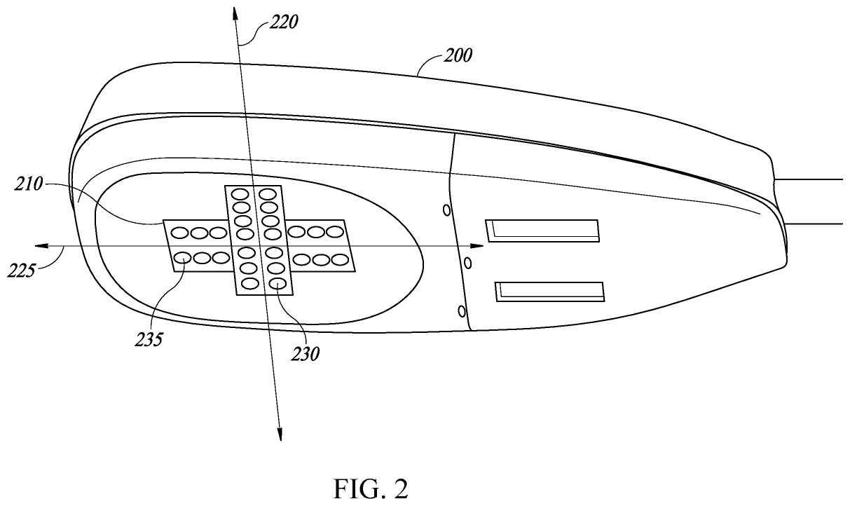

FIG. 2 shows a luminaire 200 having solid state light sources 210 arranged along two axes (220 and 225), according to at least one illustrated implementation. The first axis 220 may be aligned with an area to be illuminated (not shown), such as a roadway or pathway. The second axis 225 may be non-parallel, e.g., perpendicular, to the first axis 220. In the example depicted, a first set of solid state light sources 230, e.g., LEDs, is aligned with the first axis 220 and a second set of solid state light sources 235 is aligned with the second axis 225. The first set of LED light sources 230 may include a number of individual light sources in an elongate grid arrangement which includes multiple rows and columns of LEDs. The second set of LED light sources 235 may also include a number of individual light sources in an elongate grid arrangement. In implementations, the second set of LED light sources 235 may have a gap in a central portion thereof such that it extends from the sides of the first set of LED sources 230. Various other arrangements of LED light sources are also possible depending upon design requirements.

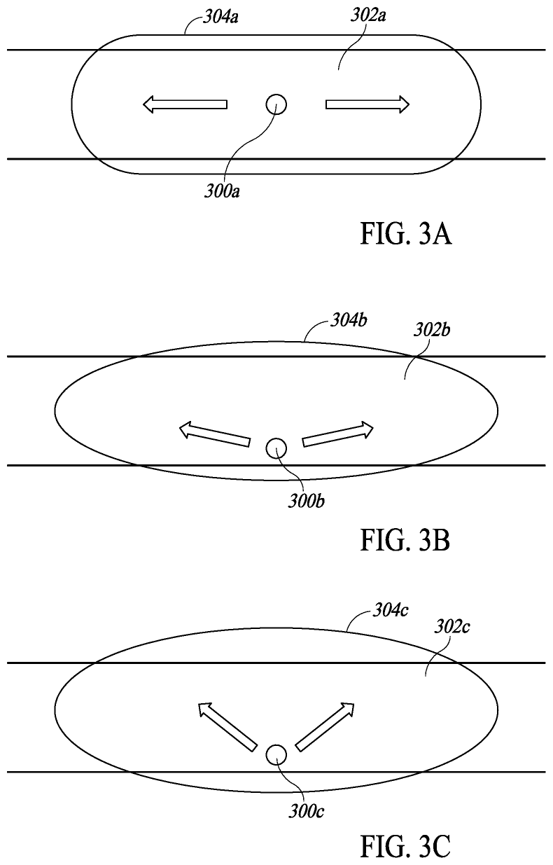

FIGS. 3A-3E depict a number of light distribution patterns established by the Illumination Engineering Society of North America (IESNA) for area, roadway, and pathway illumination. The light distribution patterns depicted are identified as Type I through Type V, respectively. Other light distribution classification systems are also in use such as the system established by the National Electrical Manufacturers Association (NEMA), which defines light distribution in terms of “beam spread.”

As shown in FIG. 3A, an IESNA Type I light distribution pattern 304a, is typically used for lighting roadways, walkways, paths, and sidewalks and is particularly suitable for narrower paths or roadways. In this type of light distribution pattern 304a, a light source 300a (or sources), e.g., a luminaire, is designed to be placed near the center of the roadway 302a. The Type I light distribution pattern 304a may be described as a two-way lateral distribution, with two concentrated light beams that illuminate in opposite directions. Type I distributions have a preferred lateral width, i.e., lateral angle, of 15 degrees in the cone of maximum candlepower and are best suited for the middle (e.g., median) of a highway or roadway that needs illumination on both sides of traffic flow. The two principal light concentrations are in opposite directions along the roadway 302a. This type of light distribution pattern 304a is generally applicable to a luminaire location near the center of a roadway 302a where the mounting height of the light source 300a is approximately equal to the roadway 302a width. In roadway lighting, the lateral angle is measured between a reference line and an illuminating width line in the cone of maximum candlepower. The illuminating width line is a radial line that passes through the point of one-half maximum candlepower on the lateral candlepower distribution curve plotted on the surface of the cone of maximum candlepower. The illuminating reference line is either of two radial lines where the surface of the cone of maximum candlepower is intersected by a vertical plane parallel to the curb line and passing through the light-center of the luminaire.

As shown in FIG. 3B, a Type II light distribution pattern 304b is suitable for roadways 302b, wider walkways, highway on-ramps, and entrance roadways, as well as other applications requiring a long, narrow lighting area. This type of light distribution pattern 304b is typically located near the side of a roadway 302b or path, such as on smaller side streets or jogging paths. Type II light distributions have a preferred lateral width of 25 degrees. They are generally applicable to a light source 300b, e.g., a luminaire, located at or near the side of relatively narrow roadways 302b, e.g., where the width of the roadway 302b is less than or equal to 1.75 times the designed mounting height. In implementations, the lateral width may be in a range which is approximately plus or minus 20% the preferred lateral width, e.g., approximately 20 degrees to 30 degrees. In such a case, the luminaire may include secondary optics, e.g., lenses and reflectors, which can direct light emitted by LED strings to form a desired illumination pattern.

As shown in FIG. 3C, a Type III light distribution pattern 304c is suitable for general roadway 302c lighting, parking areas, and other areas where a larger area of lighting is required. This type of lighting is typically placed to the side of the area to be illuminated—allowing the light to project outward and fill the area. Type III light distribution patterns have a preferred lateral width of 40 degrees. This type of light distribution pattern is applicable for a light source 300c, e.g., a luminaire, mounted at or near the side of medium-width roadways 302c or areas, e.g., where the width of the roadway 302c or area is less than or equal to 2.75 times the mounting height. In implementations, the lateral width may be in a range which is approximately plus or minus 20% the preferred lateral width (which may be rounded to the nearest 10 degrees), e.g., approximately 30 degrees to 50 degrees.

As shown in FIG. 3D, a Type IV light distribution pattern 304d illuminates a semicircular area and is suitable for mounting for roadways 302d and various types of ground areas, as well as on the sides of buildings and walls. This type of light distribution pattern 304d is particularly suitable for illuminating the perimeter of parking areas and businesses. The Type IV light distribution pattern 304d has the same intensity at angles from 90 degrees to 270 degrees has a preferred lateral width of 60 degrees. This light distribution pattern 304d is suitable for a side of roadway 302d mounting and is generally used on wide roadways 302d, e.g., where the roadway width is less than or equal to 3.7 times the mounting height.

As shown in FIG. 3E, a Type V light distribution pattern 304e produces a circular, i.e., 360°, distribution that has equal light intensity in all directions. This type of light distribution pattern 304d is suitable for a light source 300e, e.g., a luminaire, mounted at or near the center of a roadway 302e and is particularly suitable for parking areas or flooding large areas of light directly in front of the fixture. In implementations, a Type “VS” distribution (not shown) may produce an approximately square light distribution pattern.

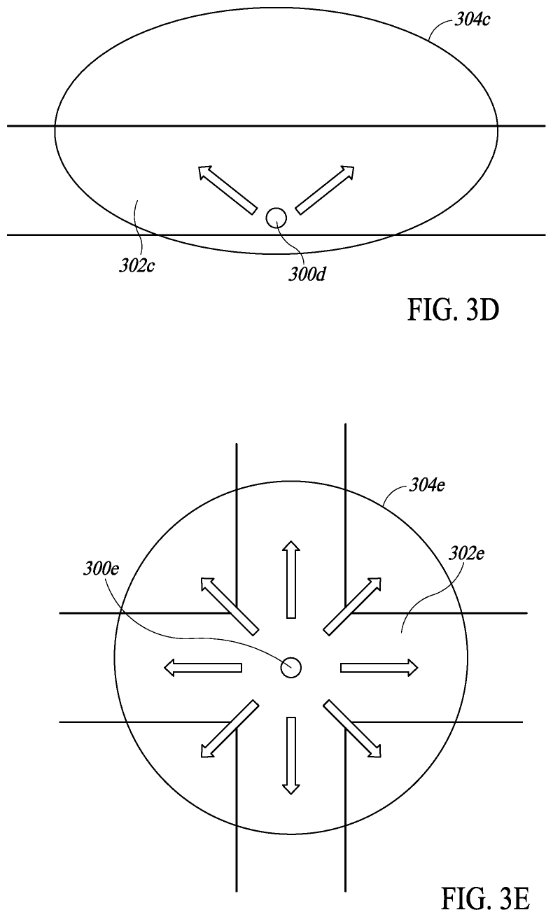

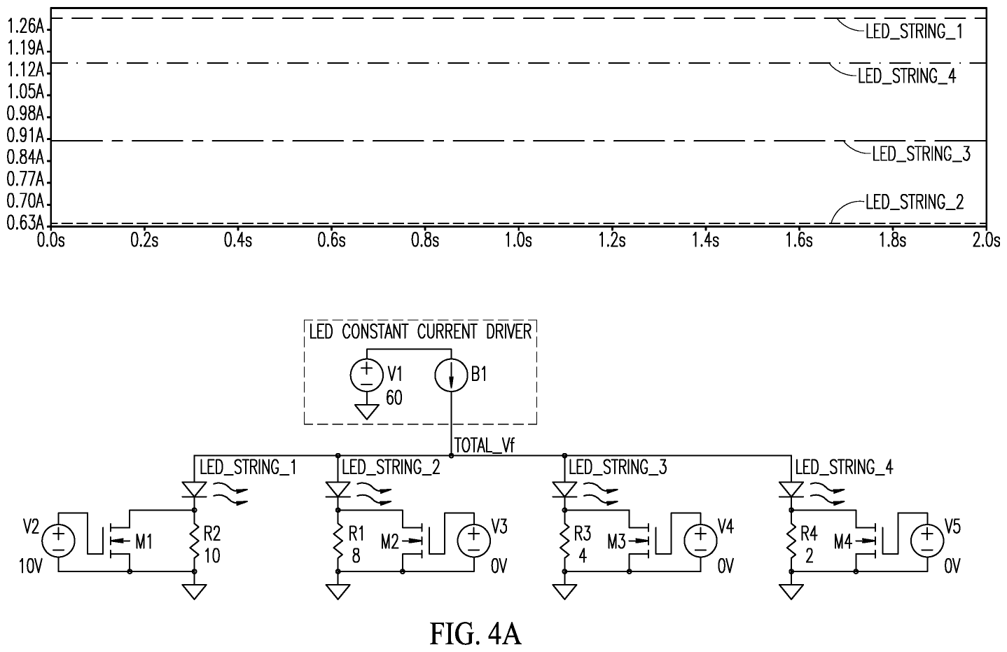

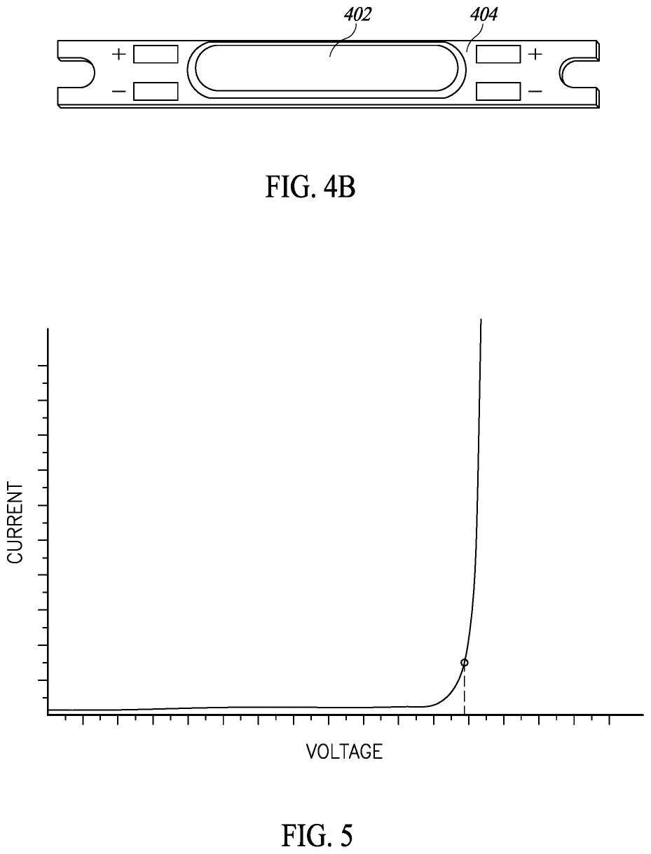

FIG. 4A is a circuit schematic diagram that shows a circuit comprising four sets of solid state light sources (e.g., LEDs) electrically coupled in parallel with one another to a constant current source, a respective resistor electrically coupled in series with each set of solid state light sources, and a respective shunt path provided via a solid state switch for each set, according to at least one illustrated implementation. As explained in further detail below, the brightness of one or more, but not all, of forward voltage matched LED strings (i.e., light source circuits) may be controlled using passive resistance with very low power loss. For example, if multiple parallel LED strings are matched in forward voltage, one or more of the strings may be dimmed to a less than their full brightness level. This may be accomplished, for example, by using a fixed or variable resistance (e.g., a combination of a resistor and a switched shunt path) in series with each light source circuit to be dimmed, which minutely lowers the voltage across the string (i.e., set) of light sources to be dimmed, such that the light sources (e.g., LEDs) conduct substantially less current and emit less light. In such a case, the forward voltage drop across both strings remains substantially the same due to the highly non-linear current versus voltage curve of the LEDs, as discussed below with respect to FIG. 5. Thus, the added resistors, in effect, “steer” the current from the constant current source so that the current is decreased in the set of light sources to be dimmed. There is a corresponding increase in current in the remaining set(s) of light sources which results in a brightening of the respective light sources. The brightened strings also maintain a forward voltage that is substantially the same—even with increased current through those strings.

In implementations, the solid state switch may be constituted by a transistor, e.g., a MOSFET. Voltages may be selectively applied to the gates of the transistors to put each switch in an on or off state. For example, the application of, e.g., 10 Volts to the gate of the MOSFET may put the MOSFET into the on state, whereas application of 0 Volts may put the MOSFET into the off state. When a solid-state switch is in the on state (i.e., a state which allows current to pass through the switch—from source to drain, or vice versa), current passes primarily through the switch, thereby effectively bypassing the resistor. When a solid state switches in the off state, the shunt path becomes an open circuit, thereby causing all of the current to flow through the resistor. Thus, in effect, the switch operates to switch the resistance into or out of the respective light source circuit. In this example, there are four light source circuits connected in parallel to the constant current source. In implementations, two of the light source circuits may be arranged along a first axis of a light, e.g., a luminaire, automobile headlamp, etc., with the two light source circuits extending from a central portion of the light in opposite directions. Similarly, the other two light source circuits may be arranged along a second axis of the light and may extend from a central portion of the light in opposite directions.

In implementations, as depicted in FIG. 4A, the resistors of the light source circuits differ in value, e.g., 2 Ohms, 4 Ohms, 8 Ohms, and 10 Ohms, respectively. In such a case, when all of the switches are in the on state, the current through each of the light source circuits will differ proportionally. In the example depicted, more current will flow through LED String 4 than through any of the other light source circuits, which means that the light sources of this string will be proportionally brighter than any of the other strings, i.e., light source circuits. Such a configuration, in effect, creates a default state in which the light source circuits have differing levels of brightness. As the switches are selectively activated or deactivated, various combinations of brightness for the light source circuits can be achieved.

FIG. 4B is a plan view of a set of LEDs 402 in a chip-on-board configuration mounted on a metal heatsink 404. The term “chip-on-board” (COB) refers to the mounting of bare LED chips in direct contact with a substrate (e.g., silicon carbide or sapphire), which allows for a much higher packing density of a set of LEDs than in conventional configurations, such as surface mounted devices. In implementations, each of the four strings may be a single chip-on-board (COB) LED array. In some cases, off-the-shelf COBs may be well enough matched in forward voltage so that no additional matching circuitry is needed. In implementations, the forward voltage of a set of COBs may be within a range of +/−1% of a nominal value for a given test current. In some implementations, the forward voltage of a set of COBs may be within +/−0.2% of a nominal value for a given test current. The four COBs may be mounted on an isothermal plane composed of an aluminum heatsink. All LEDs are maintained at substantially the same temperature, e.g., by use of thermal interface compounds, heat spreading materials, and the like. The isothermal construction of the LED strings with respect to each other prevents unwanted forward voltage changes of one string relative to another in the case of ambient temperature extremes or due to self-heating of the un-dimmed strings relative to the dimmed strings. That is, LEDs may exhibit a negative thermal coefficient of forward voltage of approximately 3 mV/° C. Therefore, a string of, e.g., 18 LEDs may increase in forward voltage by approximately 0.05 V/° C.

In implementations, matched COB LED strings may be driven by a single constant current LED driver, such as a XLG-200-H-AB from MeanWell Corporation. The COB LEDs may be mounted in a “diamond” shape, such that two of the LED strings are aligned along a first axis parallel to an area of desired maximum illumination, e.g., a roadway. The other two LED strings may be aligned along a second axis which is non-parallel (e.g., perpendicular) to the area of maximum illumination. In one example, passive resistive dimming elements (e.g., resistors) may be inserted into the perpendicular strings (i.e., the strings aligned along the second axis) so as to dim them to a low level by means of a static switch, e.g., a rotary switch. Alternatively, a MOSFET or other semiconductor switch can be used as the static switch. With the two perpendicular LED strings dimmed to a low level, or dimmed to off, the resulting light pattern from this light source may be an IESNA Type 2 roadway illumination pattern (see FIG. 3B). In another example, one of the perpendicular LED string extending toward the roadway could be “un-dimmed” by shorting the passive dimming resistor (e.g., by closing a switch in a shunt path which bypasses the resistor), by substituting a resistor of a different resistance value, by changing the static switch to a different position, or by activating a different semiconductor static switch. This case may give a resulting light pattern such as an IESNA Type 3 roadway illumination pattern (see FIG. 3C). In another example, if all of the LED stings are un-dimmed by means of changing the resistive dimmers to a low resistance, an illumination pattern substantially corresponding to an IESNA Type 5 roadway illumination pattern may result (see FIG. 3E). Thus, a single rotary switch, or one or more semiconductor switches, could control the illumination patterns of a luminaire to enable the selection of an appropriate light pattern at the time of installation or after installation.

Referring again to FIG. 4A, the depicted example is an implementation with multiple MOSFET switches and series resistors (and a plot of the current through each LED string obtained by simulation). In this example, MOSFET M1 is switched to a very low resistance by gate voltage V1 and shorts resistor R2 thereby effectively removing it from the circuit. A larger current flows through LED String 1 (e.g., about 2 amps) than through any of the other LED strings so that more light is emitted from LED String 1. For example, LED String 2 may have a current of about 0.65 amps, LED String 3 may have a current of 0.9 amps, and LED String 4 may have a current of about 1.15 amps. The illumination pattern produced by this configuration has light emitted from LED String 1 more represented than each of the other LED strings, thereby shaping the illumination pattern produced by the combined array. LED String 2 has the largest series resistance, and therefore the lowest voltage across the LED string, and emits the least light relative to the other LED strings.

FIG. 5 is a plot of current versus voltage for a number of interconnected solid-state light sources of a light source circuit, according to at least one illustrated implementation. The plot shows that there is a highly non-linear relationship of LED current to applied voltage. As explained above, the brightness of one or more (but not all) of the light source circuits, e.g., forward voltage matched LED strings, may be controlled using passive resistance with very low power loss, because the forward voltage drop across the dimmed strings remains substantially the same due to the highly non-linear current versus voltage curve of LEDs, with the un-dimmed string maintaining a similar forward voltage even with increased current through that LED string. In implementations, the forward voltage, Vf, on a full-on string of LEDs may be about, e.g., 50.0 V, while the Vf of a dimmed string may be about, e.g., 47.4 V, which is about 6% lower than the full-on string.

In implementations, a passive resistor-based dimming circuit dissipates a small amount of power due to the highly non-linear current versus voltage nature of LEDs. A resistive dissipation of approximately 2% of the total power of the LED strings without dimming has been found when one string has a passive dimming resistive element causing the light output of the dimmed string to be approximately 10% of the non-dimmed string. In such cases, the total power consumed by all matched strings is very close to the same whether dimming is used or not. For example, a 200 W LED driver driving four matched strings has been shown to draw 192 W from a 120 VAC line with no strings dimmed. If one string is dimmed by a series resistance of 50 Ohms, the total power consumed increases only to 194 W. The three un-dimmed strings become correspondingly brighter relative to the dimmed string. This provides the significant benefit of a substantially constant light output of the combined matched LED strings.

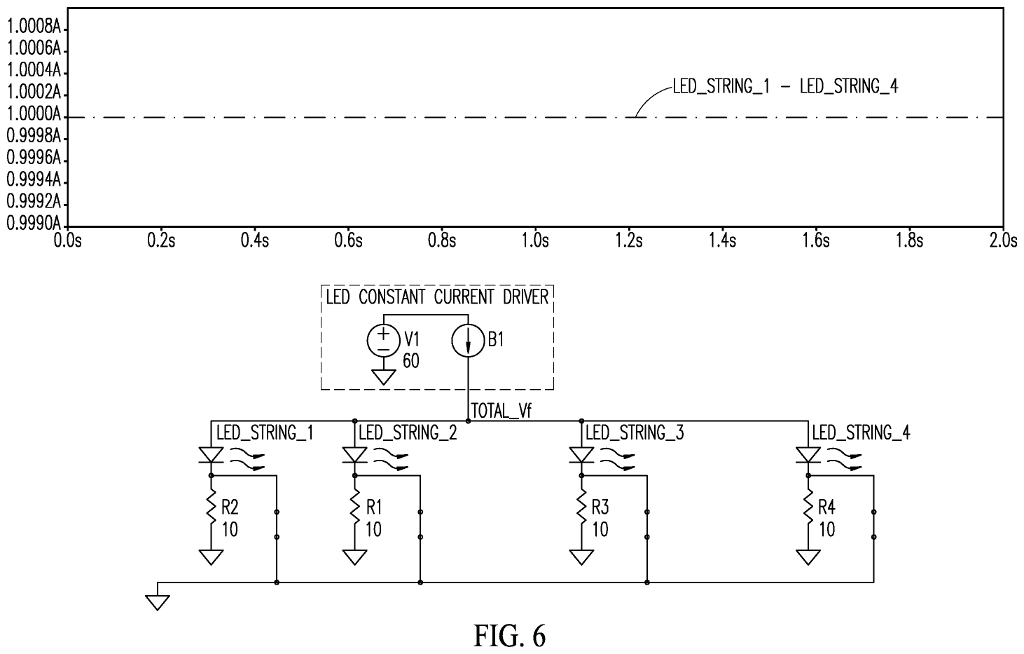

FIG. 6 is a circuit schematic diagram that shows a circuit comprising four sets of solid state light sources (e.g., LEDs) electrically coupled in parallel with one another to a constant current source, a respective resistor, and respective shunt path with a switch, the resistors having a same value of resistance as one another, the switches illustrated in an closed (i.e., “on”) state and providing a shunt path around the corresponding resistors, according to at least one illustrated implementation. In the example depicted, when all of the switches are in the “on” state, all of the resistors are bypassed, i.e., shunted, and the current through each of the light source circuits will be the same, e.g., about 1 amp. Thus, the default state created in this configuration is one in which the brightness of each of the light source circuits is the same. As the switches are selectively activated (i.e., turned on to allow current to flow) or deactivated (i.e., turned off to block current flow), thereby selectively providing a shunt path around the resistor or an open circuit which forces all of the current through the resistor, respectively, various combinations of brightness for the light source circuits can be achieved. In operation, all of the switches could be put into the on position so that all of the resistors were bypassed (as depicted here), resulting in equal illumination for all four of the light source circuits, thereby providing the illumination for an IESNA Type V light distribution pattern.

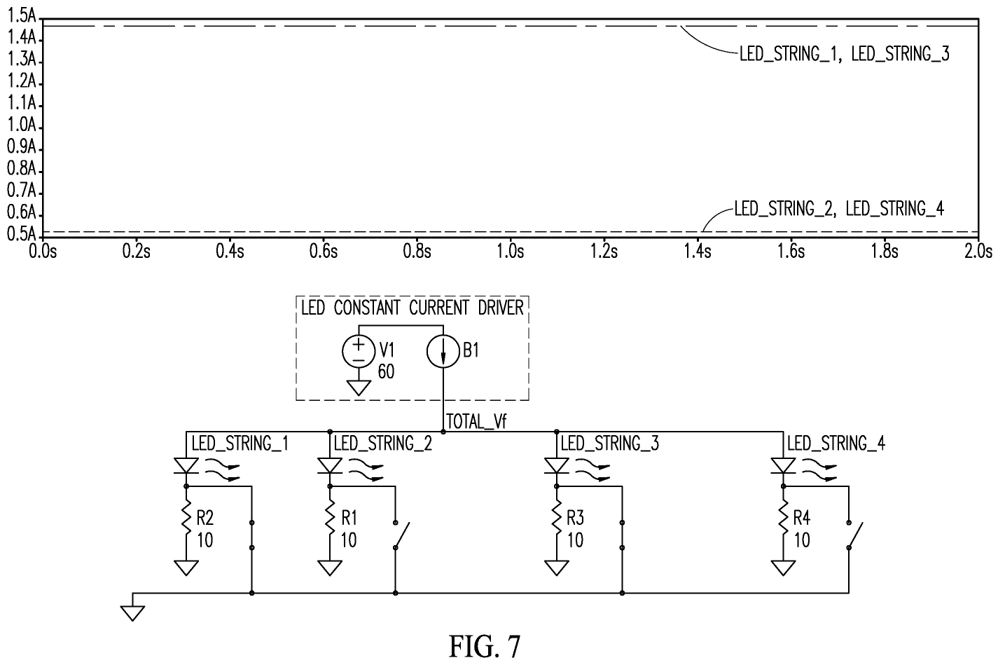

FIG. 7 is a circuit schematic diagram that shows a circuit comprising four sets of solid state light sources (e.g., LEDs) electrically coupled in parallel with one another to a constant current source, a respective resistor, and respective shunt path with a switch for each set, the resistors having a same value of resistance as one another, two of the switches illustrated as in an open (i.e., “off”) state, thus not providing a shunt around the corresponding resistors, and two of the switches illustrated as in a closed (i.e., “on”) state to provide shunts around the corresponding resistors, according to at least one illustrated implementation. As in the implementation depicted in FIG. 6, the default state created in this configuration is one in which the brightness of each of the light source circuits is the same, and as the switches are selectively activated or deactivated various combinations of brightness for the light source circuits can be achieved. For example, two of the switches can be put into the off position to switch the, e.g., 10 Ohm resistors into the two respective light source circuits, in which case the current through the shunted paths (e.g., LED String 1 and LED String 3) may be, e.g., about 1.5 amps, while the current in the paths into which the 10 ohm resistor has been switched (e.g., LED String 2 and LED String 4) may be, e.g., about 0.5 amps, thereby dimming the respective light source circuits to provide a Type II light distribution pattern.

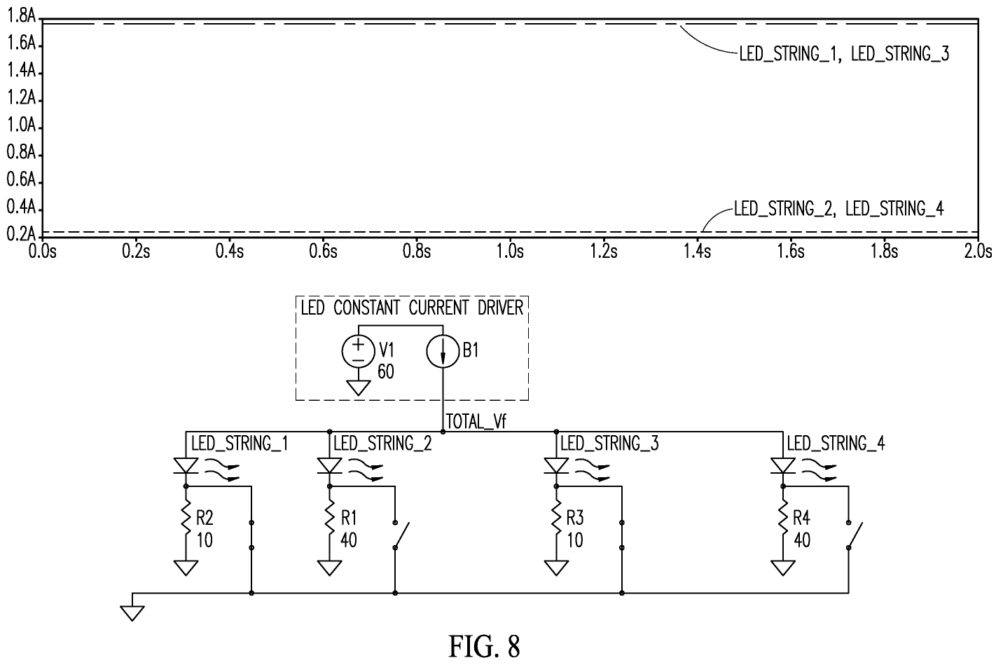

FIG. 8 is a circuit schematic diagram that shows a circuit comprising four sets of solid state light sources (e.g., LEDs) electrically coupled in with one another parallel to a constant current source, a respective resistor, and a shunt path with a switch for each set, the resistors associated with two of the sets a higher value of resistance than the resistors associated with the other two sets, two of the switches that optionally provide shunt paths around the resistors having the relatively higher resistance illustrated in an open (i.e., “off”) state, and two of the switches that optionally provide shunt paths around the resistors having relatively lower resistance illustrated in a closed (i.e., “on”) state, according to at least one illustrated implementation. In implementations, the resistors of the light source circuits differ in value, e.g., 10 Ohms, 40 Ohms, 10 Ohms, and 40 Ohms, respectively. In such a case, when all of the switches are in the on state, the current through each of the light source circuits will differ proportionally. In the example depicted, more current will flow through LED String 1 and LED String 3 than through the other two light source circuits, which means that the light sources of these strings will be proportionally brighter than any of the other strings, i.e., light source circuits. Such a configuration, in effect, creates a default state in which the light source circuits have differing levels of brightness. As the switches are selectively activated or deactivated, various combinations of brightness for the light source circuits can be achieved. For example, two of the switches can be put into the off position to switch the, e.g., 40 Ohm resistors into the two respective light source circuits, thereby dimming the respective light source circuits to provide a Type II light distribution pattern.

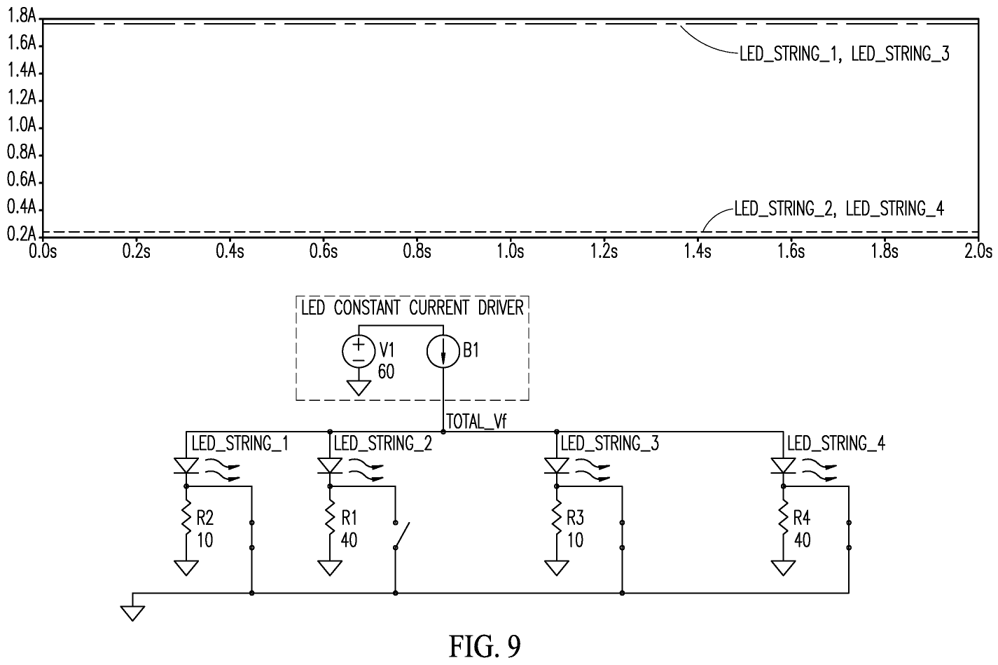

FIG. 9 is a circuit schematic diagram that shows a circuit comprising four sets of solid state light sources (e.g., LEDs) electrically coupled in parallel with one another to a constant current source, a respective resistor, and a shunt path with a switch for each set, the resistors of two of the sets having a higher resistance than the resistors of the other two sets, the switch that optionally provides one of the shunt paths around one of the resistors having the relatively lower resistance being illustrated in an open (i.e., “off”) state, and the switches that optionally provide the other shunt paths illustrated in a closed (i.e., “on”) state, according to at least one illustrated implementation. In implementations, the resistors of the light source circuits differ in value, e.g., 10 Ohms, 40 Ohms, 10 Ohms, and 40 Ohms, respectively. In such a case, when all of the switches are in the on state, the current through each of the light source circuits will differ proportionally. In the example depicted, more current will flow through LED String 1 and LED String 3 than through the other two light source circuits, which means that the light sources of these strings will be proportionally brighter than any of the other strings, i.e., light source circuits. Such a configuration, in effect, creates a default state in which the light source circuits have differing levels of brightness. As the switches are selectively activated or deactivated, various combinations of brightness for the light source circuits can be achieved. For example, one of the switches can be put into the off position to switch one of the, e.g., 40 Ohm resistors into the respective light source circuit, thereby dimming the respective light source circuit to provide a Type IV light distribution pattern

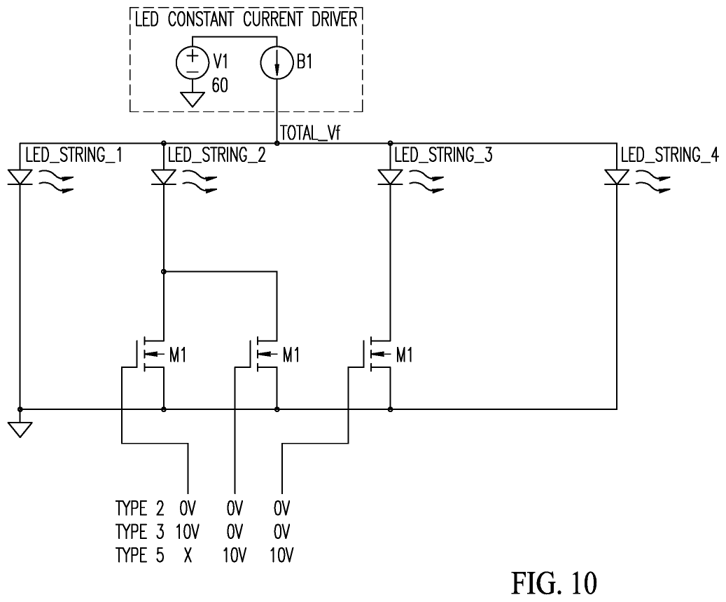

FIG. 10 is a circuit schematic diagram that shows a circuit comprising four sets of solid state light sources (e.g., LEDs) electrically coupled in parallel to a constant current source, a resistor and a first switch electrically coupled in series with one of the sets of solid state light sources along with a switch that provides a shunt path to bypass the resistor, another switch electrically coupled to another one of the sets of solid state light sources without a respective resistor or shunt path, according to at least one illustrated implementation. In the example depicted, three MOSFET transistors control two of four matched LED strings, i.e., light source circuits, to allow the output of the light to be switched to an IESNA Type II, Type III, or Type V using, for example, a mechanical rotary switch or slide switch, independent mechanical switches, or by output lines from a microcontroller. A state table presented in FIG. 10 indicates which MOSFETs are switched to conduction mode, i.e., switched to an “on” state, to achieve each of these light distributions types.

In implementations, to achieve a Type II light distribution output (see FIG. 3B), an input of 0 Volts is applied to each of the three MOSFET switches—putting the switches in the “off” state. In such a case, both LED String 1 and LED String 4 are connected to ground such that current flows through the LEDs corresponding to these light source circuits, which may be arranged along a first axis which is aligned with an elongate area being illuminated, e.g., a roadway. In addition, both LED String 2 and LED String 3 are open circuited so that no current flows to the corresponding light sources, which may be light sources arranged along a second axis which is perpendicular to the first axis and therefore in a direction perpendicular to the elongate area being illuminated.

To achieve a Type III light distribution output (see FIG. 3C), an input of 0 Volts is applied to two of the three MOSFET switches (putting the switches in the “off” state), specifically, the MOSFET in the shunt path of LED String 2 and the MOSFET in the path of LED String 3. An input of 10 Volts is applied to the MOSFET in the resistor path of LED String 2. In such a case, both LED String 1 and LED String 4 are connected to ground such that current flows through the LEDs corresponding to these light source circuits, which may be arranged along a first axis which is aligned with an elongate area being illuminated, e.g., a roadway. In addition, LED String 2 is connected to ground through its resistor path such that the LEDs corresponding to this light source circuit are illuminated but dimmed with respect to LED String 1 and LED String 2. The LEDs corresponding to LED String 2 may be arranged along a second axis which is perpendicular to an elongate area being illuminated, e.g., a roadway, in a forward direction of the light (e.g., a direction toward the roadway). LED String 3 is open circuited so that no current flows to the corresponding light sources, which may be light sources arranged along the second axis but in a rearward direction of the light (e.g., a direction away from the roadway and toward residences and/or businesses).

To achieve a Type IV light distribution output (see FIG. 3E), an input of 10 Volts is applied to the MOSFETs in the shunt path of LED String 2 and the path of LED String 3. In such a case, both LED String 1 and LED String 4 are connected to ground such that current flows through the LEDs corresponding to these light source circuits, which may be arranged along a first axis which is aligned with an elongate area being illuminated, e.g., a roadway. In addition, LED String 2 is connected to ground through its shunt path (the MOSFET in series with the resistor LED String 2 can be on or off—an “x” or “don't care” input) and LED String 3 is also connected to ground such that current flows through the LEDs corresponding to these light source circuits without dimming relative to the other light source circuits. The LEDs corresponding to these light source circuits may be arranged along a second axis which is perpendicular to the elongate area being illuminated.

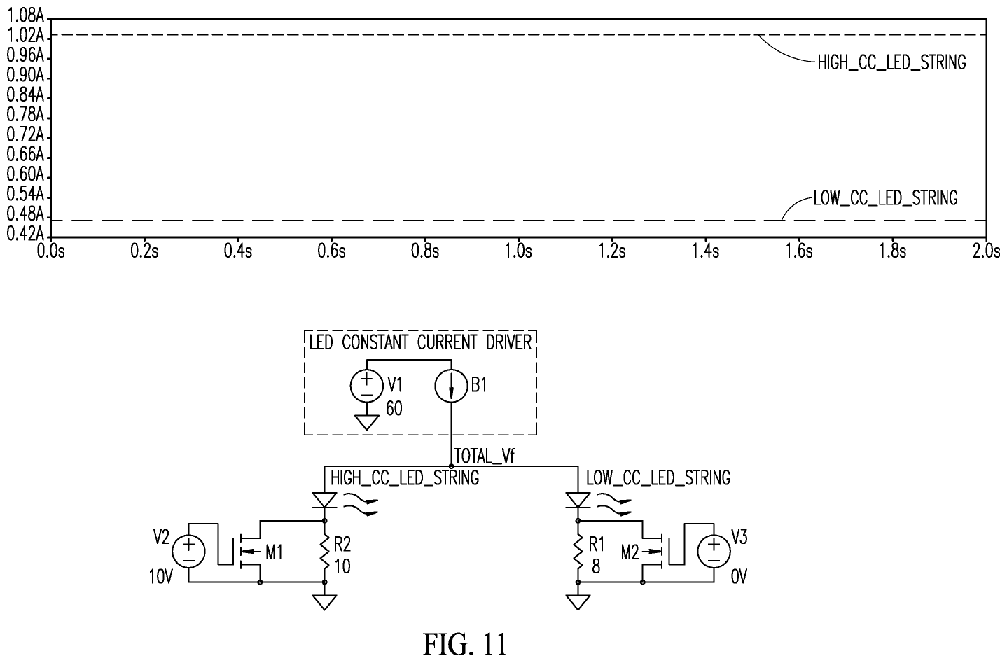

FIG. 11 shows two light source circuits connected in parallel to a constant current source, each light source circuit including a number of solid state light sources, a resistor, and a shunt path with a switch, the light sources of one of the light source circuits having a higher color temperature than the light sources of the other light source circuit, according to at least one illustrated implementation. In implementations, a number of matched LED strings (e.g., two strings) of different color spectrums are connected in parallel, where one string may be a higher color temperature, e.g., 5600K Correlated Color Temperature (CCT), and the other string may have a lower color temperature, e.g., 2200K CCT. In such a case, the current from the constant current LED driver may be steered mostly through the 5600K LED string to produce a cooler light emission spectrum or through the 2200K LED string to produce a warmer spectrum. In this way, a luminaire may have an adjustable emission spectrum so that one model of a light or luminaire may be used in multiple applications. In the example depicted, solid state switches, e.g., MOSFET transistors (M1 and M2), may be used to switch in the respective dimming resistors by opening or closing a shunt path which bypasses each respective resistor. In implementations, multiple MOSFETs, each connected with a different value resistor, may be used to make multiple steps of light color adjustment. In the example depicted, a 10 ohm resistor (R1) is used to selectively lower the forward voltage of the Low_CCT_LED string. The MOSFET (M1) shorts resistor R2, thereby removing it from the circuit. This results in more current from the constant current supply flowing through the High CCT LED string than the Low CCT string, thereby increasing CCT of the combination of the two strings.

The various embodiments described above can be combined and/or modified to provide further embodiments in light of the above-detailed description, including the material incorporated by reference. All of the U.S. patents, U.S. patent application publications, U.S. patent applications, foreign patents, foreign patent applications and non-patent publications referred to in this specification and/or listed in the Application Data Sheet, including but not limited to U.S. Provisional Application No. 62/930,283, filed Nov. 4, 2019, are incorporated herein by reference, in their entirety. Aspects of the embodiments can be modified, if necessary to employ concepts of the various patents, applications and publications to provide yet further embodiments.

In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A light comprising:
a first set of one or more electrically coupled solid state light sources having a first forward voltage drop across the first set of solid state light sources;
a second set of one or more electrically coupled solid state light sources having a second forward voltage drop across the second set of solid state light sources, the second forward voltage drop at least approximately matching the first forward voltage drop;
a constant current source to which the first set of solid state light sources and at least the second set of solid state light sources are electrically coupled in parallel;
at least one resistor electrically coupled to at least one of the first set and the second set of solid state light sources; and
a set of control circuitry that is operably coupled to control a resistance electrically coupled in series with said at least one of the first set and the second set of solid state light sources, the resistance being provided by said at least one resistor, to adjust a respective current through said at least one of the first set and the second set of solid state light sources and thereby dim said at least one of the first set and the second set of solid state light sources while maintaining the respective forward voltage drop across the first set and the second set of solid state light sources substantially constant.

2. The light of claim 1 wherein the set of control circuitry is operably coupled to control the resistance electrically coupled in series with said at least one of the first set and the second set of solid state light sources, the resistance being provided by said at least one resistor, to adjust the respective current through said at least one of the first set and the second set of solid state light sources and thereby dim said at least one of the first set and the second set of solid state light sources and to brighten correspondingly another one of the first set and the second set of solid state light sources.

3. The light of claim 1 wherein the set of control circuitry comprises:
a shunt path bypassing said at least one resistor; and
at least one switch operable in a first state to cause current to pass through said at least one resistor and operable in a second state to cause current to pass through the shunt path.

4. The light of claim 3 wherein said at least one switch comprises a solid state switch.

5. The light of claim 3 wherein said at least one switch comprises a mechanical or electromechanical switch.

6. The light of claim 1 wherein said at least one resistor is a variable resistor and the set of control circuitry is operable to adjust a resistance of the variable resistor.

7. The light of claim 1 wherein the first set and the second set of solid state light sources each comprise a chip-on-board light emitting diode circuit.

8. The light of claim 1 wherein the first set and the second set of solid state light sources are communicatively coupled to a common isothermal structure comprising a heatsink.

9. The light of claim 1 wherein the first set and the second set of solid state light sources have a negative thermal coefficient of less than about 3 millivolts per degree Celsius.

10. The light of claim 1 wherein:
the first set of one or more solid state light sources has a first correlated color temperature and the second set of one or more solid state light sources has a second correlated color temperature, the first correlated color temperature being different from the second correlated color temperature, and
the set of control circuitry is operably coupled to control the resistance electrically coupled in series with said at least one of the first set and the second set of solid state light sources, the resistance being provided by said at least one resistor, to adjust the respective current through said at least one of the first set and the second set of solid state light sources and thereby dim said at least one of the first set and the second set of solid state light sources to output light having a combined correlated color temperature in a range between the first correlated color temperature and the second correlated color temperature.

11. The light of claim 1 wherein at least the second set of one or more solid state light sources is arranged to extend along a first axis and at least the first set of one or more solid state light sources is arranged to extend along a second axis, the second axis being non-parallel to the first axis.

12. The light of claim 11 wherein the second axis is perpendicular to the first axis and the light further comprises a mount positioned and oriented to allow installation of the light so that the first axis is aligned with an elongate area to provide maximum illumination to the elongate area and the second axis is aligned perpendicularly to the elongate area.

13. The light of claim 11 wherein at least the first set of one or more solid state light sources is selectively dimmable to form:
a first illumination pattern; and
a second illumination pattern, the second illumination pattern different than the first illumination pattern.

14. The light of claim 13 wherein the first illumination pattern provides maximum illumination to an elongate area with a light distribution having a lateral width of between about 20 degrees and about 30 degrees, the second illumination pattern which provides maximum illumination to an elongate area with a light distribution having a lateral width of between about 30 degrees and about 50 degrees, and at least the first set of one or more solid state light sources is selectively dimmable to further form a third illumination pattern which provides maximum illumination to a circular area.

15. The light of claim 14 wherein the first, second, and third illumination patterns correspond to IESNA Types II, III, and V light distribution patterns, respectively.

16. The light of claim 1, further comprising:
a third set of one or more electrically coupled solid state light sources having a third forward voltage drop across the third set of solid state light sources, the third forward voltage drop at least approximately matching the first forward voltage drop, wherein:
the first set, the second set, and the third set of solid state light sources are electrically coupled to the constant current source in parallel,
said at least one resistor is electrically coupled to at least one of the first set, the second set, and the third set of solid state light sources, and
the set of control circuitry is operably coupled to control a resistance electrically coupled in series with said at least one of the first set, the second set, and the third set of solid state light sources, the resistance being provided by said at least one resistor, to adjust a respective current through said at least one of the first set, the second set, and the third set of solid state light sources and thereby dim said at least one of the first set, the second set, and the third set of solid state light sources, wherein the control circuitry is operable to selectively dim one or more of the first, the second and the third sets of one or more solid state light sources to at least one of adjust a combined color temperature output by the light or to adjust a combined illumination pattern produced by the light.

17. A method to control a light comprising a first set of one or more electrically coupled solid state light sources having a first forward voltage drop across the first set of solid state light sources, and a second set of one or more electrically coupled solid state light sources having a second forward voltage drop across the second set of solid state light sources, the second forward voltage drop at least approximately matching the first forward voltage drop, the method comprising:
receiving current from a constant current source to which the first set of solid state light sources and at least the second set of solid state light sources are electrically coupled in parallel; and
controlling, using an operably coupled set of control circuitry, a resistance electrically coupled in series with said at least one of the first set and the second set of solid state light sources, the resistance provided by at least one resistor electrically coupled to at least one of the first set and the second set of solid state light sources, to adjust a respective current through said at least one of the first set and the second set of solid state light sources and thereby dim said at least one of the first set and the second set of solid state light sources.

18. The method of claim 17 wherein, in said controlling the resistance electrically coupled in series with said at least one of the first set and the second set of solid state light sources to adjust the respective current through said at least one of the first set and the second set of solid state light sources and thereby dim said at least one of the first set and the second set of solid state light sources, the respective forward voltage drop across the first set and the second set of solid state light sources remain substantially constant.

19. The method of claim 17 wherein the first set of one or more solid state light sources has a first correlated color temperature and the second set of one or more solid state light sources has a second correlated color temperature, the first correlated color temperature being different from the second correlated color temperature, and
wherein controlling the resistance electrically coupled in series with said at least one of the first set and the second set of solid state light sources to adjust the respective current through said at least one of the first set and the second set of solid state light sources includes controlling the resistance to output light having a combined correlated color temperature in a range between the first correlated color temperature and the second correlated color temperature.

20. The method of claim 17 wherein the light further comprises a third set of one or more electrically coupled solid state light sources having a third forward voltage drop across the third set of solid state light sources, and at least a fourth set of one or more electrically coupled solid state light sources having a fourth forward voltage drop across the fourth set of solid state light sources, the third and the fourth forward voltage drops at least approximately matching the first forward voltage drop, and at least one of the third or the fourth sets of one or more electrically coupled solid state light sources extending in a direction that is non-parallel a direction in which at least one of the first or the second sets of one or more electrically coupled solid state light sources extend, and wherein:
controlling the resistance electrically coupled in series with said at least one of the first set and the second set of solid state light sources to adjust the respective current through said at least one of the first set and the second set of solid state light sources includes controlling a resistance electrically coupled in series with said first, second, third and fourth sets of one or more electrically coupled solid state light sources to select a throw pattern cast by the light.
